(19) United States
(12) Patent Application Publication
(10) Pub. No.: US 2013/0030884 A1
(43) Pub. Date: Jan. 31, 2013

(54) EDUCATION BASED ON COMMERCIAL CREDIT POINT AWARD

(71) Applicants: Robert Branch Faber, Nashville, TN (US); James Furman Buzhardt, Nashville, TN (US)

(72) Inventors: Robert Branch Faber, Nashville, TN (US); James Furman Buzhardt, Nashville, TN (US)

(21) Appl. No.: 13/190,383

(22) Filed: Jul. 25, 2011

(51) Int. Cl. G06Q 30/02

(52) U.S. Cl. 705/14.1

(57) ABSTRACT

Apparatus and methods are disclosed including client and/or server computing devices, such as smartphones, laptop computers, servers, and the like, having application software thereon configured to award credit points towards the purchase of goods and services from third parties upon meeting predefined milestones associated with the taking of online tests, educational courses or modules.

### TECHNICAL FIELD

This application relates generally to education. More specifically, this application relates to online education, which may result in a reward.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example arrangement of client, server, and third party entities; and

FIGS. 4A-4C show example display areas configured to interact with a user taking an online course.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular types of commercial incentives, such as coupons for purchase of food, it will be appreciated that the disclosure may be used with other types of commercial marketing arrangements, such as providing award points towards purchase of airline tickets, clothing, and the like; or awards offered by educational institutions such as books or free lectures and courses, etc.

Briefly described, in various embodiments, a device and a method are disclosed including client and/or server computing devices of any complexity, such as smartphones, laptop computers, servers, and the like, having application software associated therewith configured to award credit points towards the purchase of goods and services from third parties upon meeting predefined milestones associated with the taking of online educational courses or modules. The award may be in the form of a voucher, a coupon, credit points, gift cards, products, services, or any other form of benefit.

Online (network accessible) services and commerce have become ubiquitous in the recent years for individuals and businesses alike. A highly visible and common online tool to access information, services, and goods is the world wide web (web) via the Internet, as further described below.

With the ubiquity of users' Internet access there is an ever increasing demand for expanded services, entertainment, education, and the like. For example, many people, including children, spend considerable time online looking for and playing games. This online time may be utilized by users to learn useful skills from online sources, for example, by taking online courses or educational modules. However, users, especially children, may not be inclined to spend their online time for educational purposes, unless there are additional incentives. Furthermore, service providers may be able to offer goods and services, which are of interest to such online users while the users are also gaining knowledge and skills.

### Illustrative Operating Environment

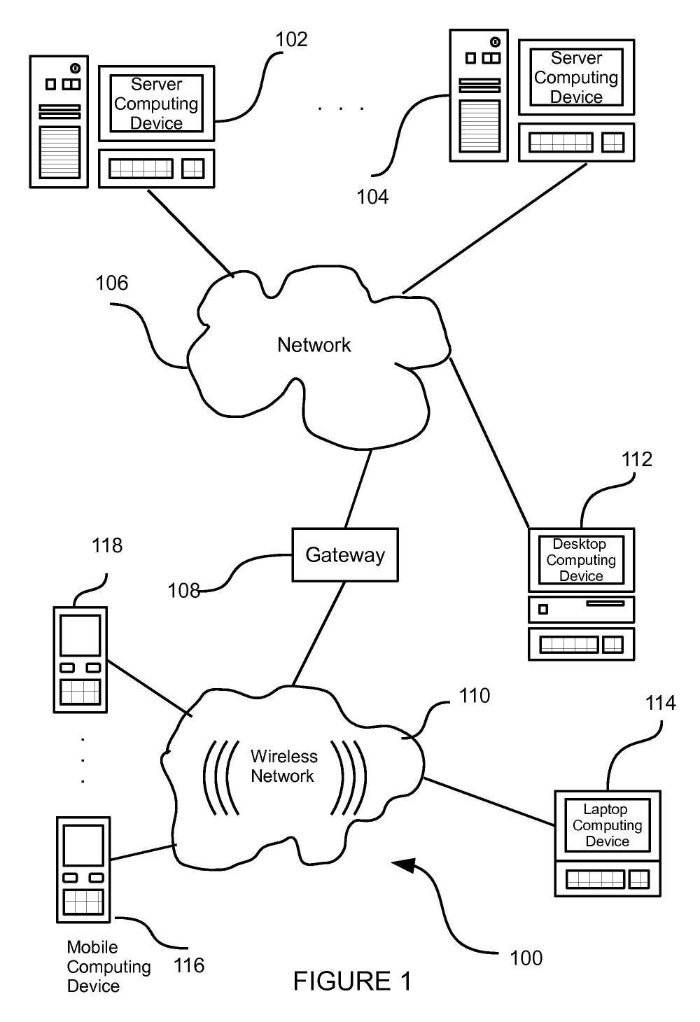

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

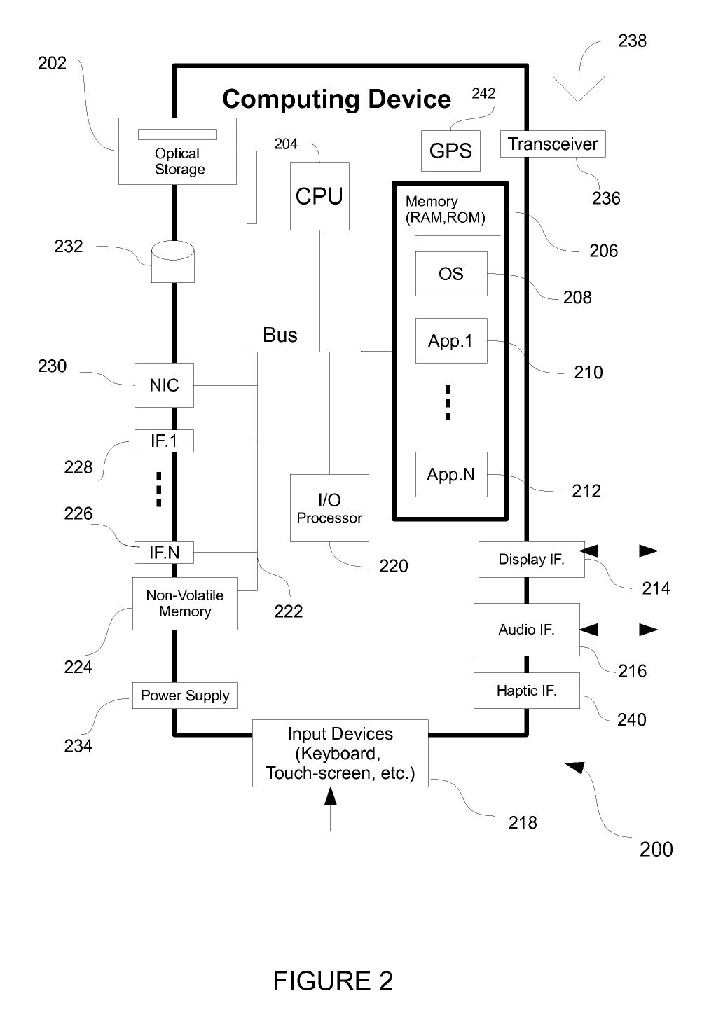

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4^{th} (4G), generation and any future generation technologies for radio access for cellular systems, WLAN, Wireless Router (WR) mesh, and the like. Access technologies such as 3G, 4G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client communication operating system such as Windows Mobile™, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), HDMI (High Definition Multimedia Interface), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

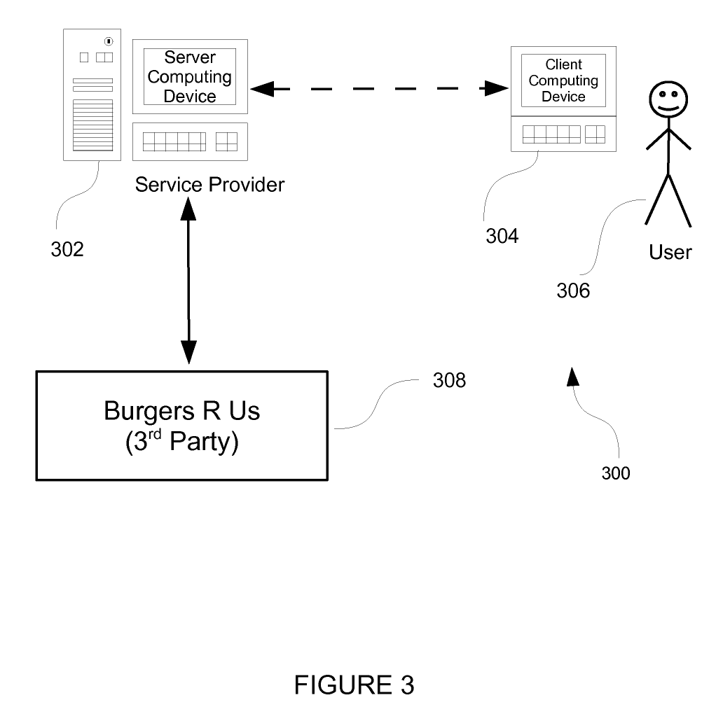

FIG. 3 shows an example arrangement of client, server, and third party entities. Arrangement 300 includes server computing device 302 provided by a service provider, client computing device 303 coupled with server computing device 302, user 306 using the client computing device, and third party 308 having a commercial relationship with the service provider. In various embodiments, the server computing device may be owned and/or operated by the third party entity.

Server computing device 302 and client computing device 304 may be any of the computing devices described above with respect to FIGS. 1 and 2. In various embodiments, an educational software application may be loaded to execute on server computing device 302 and/or client computing device 304, and configured to provide a user interface to user 306 via which the user may interact with the educational software application. Those skilled in the art will appreciate that the educational software application may include one or more modules and may be localized to one machine and be a stand-alone application, or be distributed over several machines and be accessed over a computer network. In distributed embodiments, the software application may have multiple software modules, which communicate and coordinate their functions and services to the user by using a communication protocol to exchange instructions and data. In various embodiments, the educational software application runs on the server and interacts with the user via a computer network directly or via another application, such as a browser. In other embodiments, the educational software application runs on the client device and interacts with the user locally and transmits data from the user interactions to the service provider's server continuously or periodically.

In various embodiments, third party 308 may be a commercial merchant, such as a restaurant chain, a retail shop, an airline, an educational establishment; a government entity, such as the US Post Office; or any entity, which may provide services or goods to users in exchange for money or credit. The third party may enter into a business relationship with the service provider and agree to accept points awarded to the user by the service provider towards the purchase of goods and services provided by the third party to the user. The service provider may charge the third party for promoting the third party's goods and services. This method of marketing goods and services provides benefits to the merchants and the users by providing educational services to the users as well as making the users aware of available goods and services through the participating merchants. The award points may be used to pay for part or all of the third party's various products and services. The award may be in the form of a voucher, a coupon, credit points, gift cards, products, services, or any other form of benefit. Products and services may include fuel, clothes, shoes, food, books, toys, club memberships, repairs, and other services such as accounting, painting, and the like.

In operation, in various embodiments, with continued reference to FIG. 3, a service provider offers a rewarded education program to users. User 306 logs on to a local computer, such as client computing device 304 and launches the educational software application. The educational software application presents a user interface, such as a Graphical User Interface (GUI) to user 306, via which one or more learning modules or courses are provided to the user, from which the user may select one course to work on. User 306 follows the instructions on the screen to complete the learning module and fulfill a predefined task or challenge, such as answering a question, calculating an equation, writing a paragraph, translating a sentence into another language, selecting an answer from a multiple choice question, and the like.

In various embodiments, the educational software module is configured to evaluate the response and/or performance of the user to the questions or challenges presented by the educational software module and to determine the appropriate award for the user. The award may be in the form of a voucher, credit points, gift cards, products, services, or any other form of benefit. In some embodiments, the educational software application itself evaluates the user's response, while in other embodiments the educational software application communicates the user's response to another entity, such as another evaluation software module to evaluate the response. Once the user demonstrates a predetermined level of competence in the subject matter of the learning module, for example, by completing the learning module with no errors or only a few acceptable errors, the educational software application rewards the user by crediting a user's account with a predetermined number of credit points redeemable at participating third parties. In various embodiments, the user may be penalized for wrong answers by reducing credit points from the user's credit account. In some embodiments, the educational software application rewards the user by providing a coupon for some discount at a predetermined commercial establishment, such as a restaurant chain. The user may print the coupon and take it to the restaurant chain to redeem it for discounted food items.

In various embodiments, a new user may create a new account with this rewarded education program offered by the service provider. The new account creation process may include an initial assessment of the user's skills and interests, for example, how old the user is, what school grade the user is in, what the user is generally interested in learning, and what rewards the user may desire most, among others. The new account creation process may create a user profile based on the information collected.

In various embodiments, the user profile is dynamically updated as the user utilizes the services provided by the service provider. The educational software application collects and maintains information about the user's performance and progress in a series of learning modules or courses and sends the information to the service provider for analysis and evaluation. For example, as the user ages and acquires new knowledge and skills, the profile of the user is updated to reflect these changes. Accordingly, in some embodiments, the educational software application dynamically adapts and adjusts the learning modules it presents to the user based on the updated user's profile.

In various embodiments, the educational software application may provide an account summary report and/or a report card to the user detailing a history of the courses or learning modules the user has successfully completed, a grade for each course taken, an overall performance indicator, such as a grade point average, and an accounting of how many credit points the user has earned, spent, and retains presently.

In various embodiments, different users may form a community together, such as a virtual classroom, and complete similar courses together in competition and/or in collaboration as a group. In some embodiments, a team account may be created to earn more points. For example, a whole family may create a family account and participate in the learning activity together and enjoy the rewards together. In some embodiments, special trophies, in the form of additional points, may be awarded in a team competition for the greatest number of credit points earned.

In some embodiments, credit points are awarded for completing each course and additional credit points may be awarded when certain aggregate milestones are reached. For example, a child may complete a series of 10 math courses online and earn 100 credit points for each course completed successfully. When the child completes five of the courses and has earned 500 points, the child may be awarded an additional 100 bonus points for a total of 600 points. Those skilled in the art will appreciate that other arrangements may be made to award points without departing from the spirit of the present disclosures. For example, some more challenging courses may be offered with double points, or during some specific time periods, such as weekdays between 4-6 PM after school, a child may be offered 25% more credit points than other times, to encourage the child to spend this time learning rather than watching cartoon on the television. In various embodiments, the credit points may take different forms, such as additional coupons, coupons with deeper discounts, and the like.

In various embodiments, the credit points so earned may be embodied in a special credit card accepted at various commercial establishments for discounted goods and services. In practice, such cards are used in a manner similar to common credit cards charged at point of service. The service provider may establish a charge system, which commercial outlets may use to charge points against the user's special credit card. A user's earned credits may be accessible to third party entities and verifiable upon furnishing of an ID card in lieu of presenting any redeemable voucher, credit card or coupon.

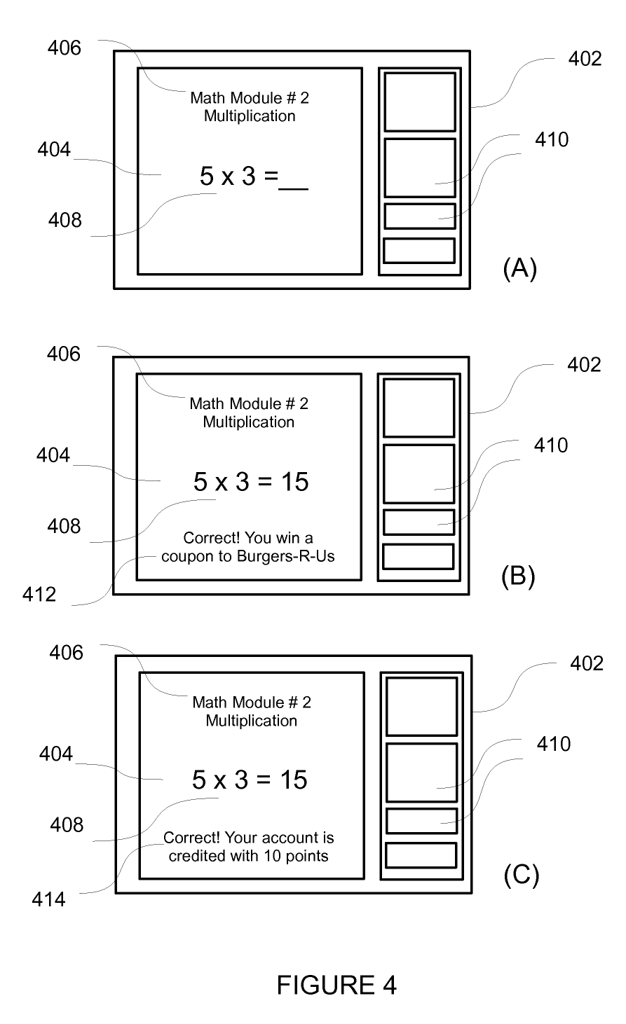

FIGS. 4A-4C show example display areas configured to interact with a user taking an online course. FIG. 4A shows an example screen presented to a user, such as a child, to solve a math multiplication program. Screen 402 includes course display area 404 including course title 406, course content 408, and promotional contents 410.

In various embodiments, the user views the educational material and course content 408 provided by the service provider and presented in course display area 404. The user prepares to successfully take a quiz, answer a question, or solve a problem related to the course content he learned before the user earns credit points. In various embodiments, the credit points are generally applicable to the purchase of goods and services at all participating third parties, while in other various embodiments, the credit points are applicable and directed only to certain goods and services related to the course content. For example, if the course being taken by the user is related to exercise and fitness, then the credit points and/or coupons awarded are only applicable to certain exercise related goods and services. In the latter case, the service provider may be able to charge third parties more because their services and goods are promoted more directly and exclusively.

Promotional content 410 may include commercial advertising, other available educational material offered through the service provider, and the like. The promotional content may or may not be related to the third party, which accepts credit points from the user. For example, some advertisements displayed to the user may be related to the third party for which coupons are awarded to the user, while other advertisements may be used to promote commercial entities other than the third party. In various embodiments, promotional content 410 is dynamically selected by the service provider and presented to the user based on various factors, such as the user profile, time of day, date, season, the course presently being viewed by the user, geographic location, age, ethnicity, sex, and the like. The user may select an advertisement link in the promotional area and be further presented with information or actions related to the link the user selected. In various embodiments, the promotional contents 410 may be dynamically changed in response to the user's answers. In some embodiments, the words a user employs in answering questions may be used to select appropriate promotional contents for display to the user. For example, if a user responds to a geography question about a tropical country with words such as “beach” or “ocean”, advertisements related to vacation spots in similar geographic areas may be selected based on these words and presented to the user on screen 402. In some embodiments, the credit points or coupons awarded may be directed to such vacation spots related to course contents.

FIG. 4B shows an example screenshot of a math module with the user's response. In this example, a user learns the course subject matter and successfully accomplishes a predefined result, such as calculating a product of a multiplication: 5×3=15. In some embodiments, as a result of completing the multiplication correctly, message 412 is displayed to the user awarding a coupon for use at a local restaurant. Instructions for printing the coupon may follow in another screen. In various embodiments, the user may be given a choice of coupons to select from.

FIG. 4C shows another example screenshot of a math module with the user's response. In this example, the user's accomplishment is rewarded by adding credit points to the user's account. Those skilled in the art will appreciate that awards, such as credit points or coupons, may be given in many different ways without departing from the spirit of the present disclosures. For example, award points may accumulate silently without notification of the user, and then the user may periodically check the status of his credits and awards at a different screen, such as an account summary page online. In other embodiments, the user may initially set up his preferences about how to accumulate credit points and be notified of rewards in a setup screen of the educational software application.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A software application that when executed on a computing device causes the computing device to:
present a user interface configured to allow a user to fulfill a predefined task;
evaluate a performance of the user in fulfilling the predefined task; and
provide award points to the user that are redeemable at a third party merchant.

2. The software application of claim 1 that when executed on a computing device further causes the computing device to display promotional contents to the user.

3. The software application of claim 2, wherein the promotional contents comprises an advertisement.

4. The software application of claim 3, wherein the advertisement is based on a user profile.

5. The software application of claim 3, wherein the advertisement is dynamically updated based on a response of the user.

6. The software application of claim 3, wherein the advertisement is related to an educational content presented to the user by the software application.

7. The software application of claim 1, wherein the predefined task comprises answering a question to an educational content presented to the user by the software application.

8. The software application of claim 1, wherein the award comprises a voucher, a coupon or a credit point redeemable at a third party merchant.

9. The software application of claim 1, wherein the predefined task is chosen by the user from a pool of predetermined tasks.

10. A method of marketing goods or services, the method comprising:
using a software application that when executed on a computing device causes the computing device to:
present a user interface configured to allow a user to fulfill a challenge; and
provide an award to or penalize the user based on the user's performance, wherein the award is redeemable at a third party merchant.

11. The method of claim 10, wherein the software application when executed on the computing device further causes the computing device to evaluate a performance of the user in fulfilling the challenge.

12. The method of claim 10, wherein the software application when executed on the computing device further causes the computing device to display an advertisement to the user.

13. The method of claim 12, wherein the advertisement is based on a profile of the user.

14. The method of claim 10, wherein the software application comprises an educational software application.

15. The method of claim 10, wherein the award comprises a coupon or credit points usable to receive a discount on or to purchase goods and services offered by the third party.

16. The method of claim 10, wherein the challenge is chosen by the user from a list of challenges.

17. A method of advertising, the method comprising:
using a software application that when executed on a computing device causes the computing device to:
present a user interface configured to allow a user to take a learning module;
test the user on the learning module; and
award points to the user based on the user's performance, wherein the award points are redeemable by a third party merchant.

18. The method of claim 17, wherein the award points are redeemable to purchase goods or services at a third party.

19. The method of claim 17, wherein the software application when executed on the computing device further causes the computing device to display an advertisement to the user.

20. The method of claim 17, wherein the advertisement is unrelated to the third party.
